(19) United States
(12) Patent Application Publication
(10) Pub. No.: US 2010/0290042 A1
(43) Pub. Date: Nov. 18, 2010

(54) Use of Free-space Coupling Between Laser Assembly, Optical Probe Head Assembly, Spectrometer Assembly and/or Other Optical Elements for Portable Optical Applications Such as Raman Instruments

(75) Inventors: Daryoosh Vakhshoori, Cambridge, MA (US); Peili Chen, Andover, MA (US); Masud Azimi, Belmont, MA (US); Peidong Wang, Carlisle, MA (US); Yu Shen, Waltham, MA (US); Kevin J. Knopp, Newburyport, MA (US); Leyun Zhu, Andover, MA (US); Christopher D. Brown, Haverhill, MA (US); Gregory H. Vander Rhodes, Melrose, MA (US)

Correspondence Address: FISH & RICHARDSON PC, P.O. BOX 1022, MINNEAPOLIS, MN, 55440-1022, US

(73) Assignee: Ahura Corporation, a Massachusetts corporation, Wilmington, MA (US)

(21) Appl. No.: 12/062,688

(22) Filed: Apr. 4, 2008

Related U.S. Application Data
(63) Continuation of application No. 11/215,526, filed on Aug. 30, 2005, now abandoned.
Application No. 11/215,526 is a continuation-in-part of application No. 11/117,940, filed on Apr. 29, 2005, now Pat. No. 7,636,157.
Application No. 11/117,940 is a continuation-in-part of application No. 11/119,076, filed on Apr. 29, 2005, now abandoned.
Application No. 11/119,076 is a continuation-in-part of application No. 11/119,139, filed on Apr. 30, 2005, now Pat. No. 7,289,208.
Application No. 11/119,139 is a continuation-in-part of application No. 11/119,147, filed on Apr. 30, 2005, now Pat. No. 7,254,501.
(60) Provisional application No. 60/605,464, filed on Aug. 30, 2004.
(60) Provisional application No. 60/615,630, filed on Oct. 4, 2004.

(51) Int. Cl. G01J 3/44

(52) U.S. Cl. 356/301

(57) ABSTRACT

An apparatus includes: a handheld Raman analyzer that can include: a common platform; a laser assembly mounted on a laser platform, the laser platform supported on the common platform by a first material and a second thermally conductive material wherein the first material is softer than the second material; an optical probe head assembly disposed on the common platform, the optical probe head assembly spaced apart from the laser assembly; a spectrometer assembly disposed on the common platform, the spectrometer assembly spaced apart from the optical probe head assembly; and an analysis apparatus configured to identify a specimen based on a Raman signature received from the spectrometer. The laser assembly can be optically coupled to the optical probe head assembly by at least a first free-space coupling region and the optical probe head assembly optically coupled to the spectrometer assembly by at least a second free-space coupling region.

### CROSS-REFERENCE TO RELATED APPLICATIONS

This patent application is a continuation of U.S. patent application Ser. No. 11/215,526, filed Aug. 30, 2005 by Daryoosh Vakhshoori et al. for USE OF FREE-SPACE COUPLING BETWEEN LASER ASSEMBLY, OPTICAL PROBE HEAD ASSEMBLY, SPECTROMETER ASSEMBLY AND/OR OTHER OPTICAL ELEMENTS FOR PORTABLE OPTICAL APPLICATIONS SUCH AS RAMAN INSTRUMENTS which

(i) is a continuation-in-part of U.S. patent application Ser. No. 11/117,940, filed Apr. 29, 2005 by Peidong Wang et al. for METHOD AND APPARATUS FOR CONDUCTING RAMAN SPECTROSCOPY (Attorney's Docket No. AHURA-2230);

(ii) is a continuation-in-part of U.S. patent application Ser. No. 11/119,076, filed Apr. 29, 2005 by Daryoosh Vakhshoori et al. for EXTERNAL CAVITY WAVELENGTH STABILIZED RAMAN LASERS INSENSITIVE TO TEMPERATURE AND/OR EXTERNAL MECHANICAL STRESSES, AND RAMAN ANALYZER UTILIZING THE SAME (Attorney's Docket No. AHURA-24);

(iii) is a continuation-in-part of U.S. patent application Ser. No. 11/119,139, filed Apr. 30, 2005 by Daryoosh Vakhshoori et al. for LOW PROFILE SPECTROMETER AND RAMAN ANALYZER UTILIZING THE SAME (Attorney's Docket No. AHURA-26);

(iv) is a continuation-in-part of U.S. patent application Ser. No. 11/119,147, filed Apr. 30, 2005 by Christopher D. Brown et al. for SPECTRUM SEARCHING METHOD THAT USES NON-CHEMICAL QUALITIES OF THE MEASUREMENT (Attorney's Docket No. AHURA-33);

(v) claims benefit of U.S. Provisional Patent Application Ser. No. 60/605,464, filed Aug. 30, 2004 by Daryoosh Vakhshoori et al. for USE OF FREE-SPACE COUPLING BETWEEN LASER, SPECTROMETER, OPTICAL PROBE HEAD, AND OTHER OPTICAL ELEMENTS FOR PORTABLE OPTICAL APPLICATIONS SUCH AS RAMAN INSTRUMENTS (Attorney's Docket No. AHURA-29 PROV); and

(vi) claims benefit of U.S. Provisional Patent Application Ser. No. 60/615,630, filed Oct. 04, 2004 by Kevin Knopp et al. for RUGGEDIZED RAMAN-BASED HANHELD CHEMICAL IDENTIFIER (Attorney's Docket No. AHURA-31 PROV).

The seven above-identified patent applications are hereby incorporated herein by reference.

### TECHNICAL FIELD

This invention relates to methods and apparatus for assembling optical circuits in general, and more particularly to methods and apparatus for assembling optical circuits used in Raman spectroscopy.

### BACKGROUND

Applications using Raman scattering signatures as a method for identifying and characterizing processes and unknown materials are expanding in the areas of security and safety, biotechnology, biomedicine, industrial process control, pharmaceutical, and other applications. This development is generally due to the rich and detailed optical signatures which can be obtained by analyzing Raman scattering of materials.

In these Raman analyzers, and looking now at FIG. 1, a stable and narrow linewidth laser assembly 2 is used as the Raman pump which impinges on the unknown material 4 through an optical probe head assembly 6, and the resulting Raman optical signal is collected through the same optical probe head assembly 6 and delivered to a spectrometer assembly 8 to identify the spectral signature of the unknown material 4. This spectral signature of the unknown material is then analyzed (e.g., using an analysis apparatus, now shown in FIG. 1) so as to identify the unknown material 4.

For portable applications, a fiber coupling 10 is typically used to connect laser assembly 2 to the optical probe head assembly 6, and another fiber coupling 12 is used to connect optical probe head assembly 6 to the spectrometer assembly 8.

Such fiber couplings have the disadvantage of increasing the size of the Raman instrument. This is because such fiber couplings require certain space considerations, e.g., connectors at both ends of the fiber, constraints on how tightly the fiber can be curved, etc. Since size and weight are generally of paramount importance in portable Raman applications, another arrangement is desirable when constructing a portable Raman analyzer.

In addition to the foregoing, the use of fiber couplings between the optical elements introduces a significant power loss to the optical circuit, which in turn requires the use of a more powerful laser, which in turn increases the Raman analyzer's power requirements, which in turn increases the size and weight of the Raman analyzer's battery. Since size and weight are generally of paramount importance in portable Raman applications, it is generally desirable to avoid significant power losses wherever possible.

The use of fiber couplings in the optical circuit also introduces an additional problem in Raman analyzers. More particularly, the passage of the laser light through the fiber creates background noise in the Raman signal, thus reducing the instrument's overall signal-to-noise ratio, and hence increasing signal collection time. However, minimizing the signal collection time is essential in handheld Raman analyzers, since they are subject to movement and vibration from their optimal positioning during operation. Thus, it would be highly desirable to produce a Raman analyzer which avoids the use of fiber couplings in its optical circuit.

### SUMMARY

This application describes a novel arrangement for coupling together the various components of an optical circuit so as to enable the construction of a compact, lightweight and highly portable device.

This application also describes a novel arrangement for coupling together the various components of a Raman analyzer so as to enable the construction of a compact, lightweight and highly portable Raman analyzer.

This application also describes a novel arrangement for coupling together the various components of the Raman analyzer so as to minimize power loss in the optical circuit, whereby to reduce laser power requirements and hence the size and weight of the analyzer's battery.

This application also describes a novel arrangement for coupling together the various components of the Raman analyzer so as to minimize noise in the optical circuit, whereby to improve the instrument's signal-to-noise ratio and hence improve signal collection time.

This application also describes a novel Raman analyzer which is compact, lightweight and highly portable.

Free-space coupling is provided between various optical elements (e.g., laser assembly, optical probe head assembly, spectrometer assembly, etc.) so as to achieve a compact optical circuit. This is done by mounting the various optical elements on a common platform which is sufficiently mechanically robust as to maintain the free-space optical coupling between the various optical elements.

In one implementation, a compact, lightweight and highly portable Raman analyzer is formed by mounting its various optical elements (i.e., laser assembly, optical probe head assembly, spectrometer assembly, etc.) to a common, mechanically robust platform, with free-space coupling between the various optical elements. Such a construction has the advantages of, among other things, reducing instrument's size and power requirements, improving the instrument's signal-to-noise ratio, and speeding up signal collection time. Furthermore, by carefully selecting each of the optical elements, an even more compact, lightweight and portable Raman analyzer can be formed.

In one embodiment, there is provided a compact, lightweight, portable optical assembly comprising: a platform; and a plurality of optical elements mounted to the platform; wherein the plurality of optical elements are optically connected to one another with free-space couplings so as to form an optical circuit; and further wherein the platform is sufficiently mechanically robust so as to maintain the free-space optical coupling between the various optical elements.

In another embodiment, there is provided a method for making a compact, lightweight, portable optical assembly, comprising: providing a platform; and mounting a plurality of optical elements to the platform; wherein the plurality of optical elements are mounted to the platform so that they are optically connected to one another with free-space couplings so as to form an optical circuit; and further wherein the platform is sufficiently mechanically robust so as to maintain the free-space optical coupling between the various optical elements.

In another embodiment, there is provided a compact, lightweight, portable Raman analyzer comprising: a platform; a laser assembly mounted to the platform; an optical probe head assembly mounted to the platform; and a spectrometer assembly mounted to the platform; wherein the laser assembly is optically connected to the optical probe assembly with a free-space coupling, and the optical probe head assembly is optically connected to the spectrometer assembly with a free-space coupling; and further wherein the platform is sufficiently mechanically robust so as to maintain the free-space optical couplings between the various optical elements.

In another embodiment, there is provided a method for making a compact, lightweight, portable Raman analyzer, comprising: providing a platform; and mounting a laser assembly to the platform, mounting an optical probe head assembly to the platform, and mounting a spectrometer assembly to the platform; wherein the laser assembly is optically connected to the optical probe head assembly with a free-space coupling, and the optical probe head assembly is optically connected to the spectrometer assembly with a free-space coupling; and further wherein the platform is sufficiently mechanically robust so as to maintain the free-space optical coupling between the various optical elements.

In another embodiment, there is provided a method for conducting a Raman analysis of a specimen, comprising: generating a Raman pump signal using a laser; passing the Raman pump signal from the laser to an optical probe head assembly using a free-space coupling; passing the Raman pump signal from the optical probe head assembly to the specimen, and receiving the resulting Raman signal from the specimen back into the optical probe head assembly; passing the received Raman signal from the optical probe head assembly to the spectrometer assembly using a free-space coupling; identifying the spectral signature of the specimen using the spectrometer assembly; and identifying the specimen using the spectral signature of the specimen.

In another embodiment, there is provided a compact, lightweight, portable Raman analyzer comprising: a laser assembly for generating a Raman pump signal; an optical probe head assembly for (i) receiving the Raman pump signal from the laser assembly, (ii) passing the Raman pump signal to a specimen, and (iii) receiving the resulting Raman signal from the specimen; and a spectrometer assembly for receiving the resulting Raman signal from the optical probe head assembly, and identifying the spectral signature of the specimen from the received Raman signal; wherein the laser assembly is spaced from the optical probe head assembly by a distance which is shorter in length than the length which would be required for a fiber coupling between the laser assembly and the optical probe head assembly; and wherein the optical probe head assembly is spaced from the spectrometer assembly by a distance which is shorter in length than the length which would be required for a fiber coupling between the optical probe head assembly and the spectrometer assembly.

In another embodiment, there is provided a compact, lightweight, portable Raman analyzer comprising: a laser assembly for generating a Raman pump signal; an optical probe head assembly for (i) receiving the Raman pump signal from the laser assembly, (ii) passing the Raman pump signal to a specimen, and (iii) receiving the resulting Raman signal from the specimen; and a spectrometer assembly for receiving the resulting Raman signal from the optical probe head assembly, and identifying the spectral signature of the specimen from the received Raman signal; wherein the laser assembly comprises an uncooled external cavity grating semiconductor laser assembly providing a stable and narrow linewidth signal.

In another embodiment, there is provided a compact, lightweight, portable Raman analyzer comprising: a laser assembly for generating a Raman pump signal; an optical probe head assembly for (i) receiving the Raman pump signal from the laser assembly, (ii) passing the Raman pump signal to a specimen, and (iii) receiving the resulting Raman signal from the specimen; and a spectrometer assembly for receiving the resulting Raman signal from the optical probe head assembly, and identifying the spectral signature of the specimen from the received Raman signal; wherein the optical probe head assembly is configured to (i) direct Raman pump light toward a specimen, and (ii) receive the resulting Raman signal from the specimen, when: (a) the specimen is disposed a fixed distance away from the optical probe head assembly; (b) the specimen is disposed a user-determined distance away from the optical probe head assembly; and (c) the specimen is disposed within the optical probe head assembly.

In another embodiment, there is provided a compact, lightweight, portable Raman analyzer comprising: a laser assembly for generating a Raman pump signal; an optical probe head assembly for (i) receiving the Raman pump signal from the laser assembly, (ii) passing the Raman pump signal to a specimen, and (iii) receiving the resulting Raman signal from the specimen; and a spectrometer assembly for receiving the resulting Raman signal from the optical probe head assembly, and identifying the spectral signature of the specimen from the received Raman signal; wherein the spectrometer assembly comprises a collimating element and a focusing element, and further wherein the collimating element and the focusing element have a reduced size in the z direction so as to permit the spectrometer assembly to have a reduced profile in the z direction while maintaining the desired optical parameters in the x-y plane.

In another embodiment, there is provided a compact, lightweight, portable Raman analyzer comprising: a platform; a laser assembly mounted to the platform; an optical probe head assembly mounted to the platform; and a spectrometer assembly mounted to the platform; wherein the laser assembly is optically connected to the optical probe assembly with a first optical coupling, and the optical probe head assembly is optically connected to the spectrometer assembly with a second optical coupling; and further wherein the first and second optical couplings are characterized by a size, power loss and noise signature which is less than a corresponding fiber coupling.

In another embodiment, there is provided a method for making a compact, lightweight, portable Raman analyzer, comprising: providing a platform; and mounting a laser assembly to the platform, mounting an optical probe head assembly to the platform, and mounting a spectrometer assembly to the platform; wherein the laser assembly is optically connected to the optical probe head assembly with a first optical coupling, and the optical probe head assembly is optically connected to the spectrometer assembly with a second optical coupling; and further wherein the first and second optical couplings are characterized by a size, power loss and noise signature which is less than a corresponding fiber coupling.

In another embodiment, there is provided a method for conducting a Raman analysis of a specimen, comprising: generating a Raman pump signal using a laser; passing the Raman pump signal from the laser to an optical probe head assembly using a first optical coupling, wherein the first optical coupling is characterized by a size, power loss and noise signature which is less than a corresponding fiber coupling; passing the Raman pump signal from the optical probe head assembly to the specimen, and receiving the resulting Raman signal from the specimen back into the optical probe head assembly; passing the received Raman signal from the optical probe head assembly to the spectrometer assembly using a second optical coupling, wherein the second optical coupling is characterized by a size, power loss and noise signature which is less than a corresponding fiber coupling; identifying the spectral signature of the specimen using the spectrometer assembly; and identifying the specimen using the spectral signature of the specimen.

In another embodiment, there is provided a compact, lightweight, portable Raman analyzer comprising: a light source for delivering excitation light to a specimen so as to generate the Raman signature for that specimen; a spectrometer for receiving the Raman signature of the specimen and determining the wavelength characteristics of that Raman signature; and analysis apparatus for receiving the wavelength information from the spectrometer and, using the same, identifying the specimen; wherein the analysis apparatus comprises a microcomputer programmed to use appropriate algorithms and material libraries to identify the specimen material from the spectral signature.

In another embodiment, there is provided a compact, lightweight, portable Raman analyzer comprising: a light source for delivering excitation light to a specimen so as to generate the Raman signature for that specimen; a spectrometer for receiving the Raman signature of the specimen and determining the wavelength characteristics of that Raman signature; and analysis apparatus for receiving the wavelength information from the spectrometer and, using the same, identifying the specimen; wherein the light source, spectrometer and analysis apparatus are all disposed on-board the Raman analyzer.

In another embodiment, there is provided a compact, lightweight, portable Raman analyzer comprising: a light source for delivering excitation light to a specimen so as to generate the Raman signature for that specimen; a spectrometer for receiving the Raman signature of the specimen and determining the wavelength characteristics of that Raman signature; and analysis apparatus for receiving the wavelength information from the spectrometer and, using the same, identifying the specimen; wherein the analysis apparatus further comprises an on-board database comprising information about different materials, and further wherein the analysis apparatus is configurable such that when the analysis apparatus identifies the specimen material, the analysis apparatus also provides the user with information about that identified material.

The details of one or more embodiments are set forth in the accompanying drawings and the description below. Other features and advantages will be apparent from the description and drawings, and from the claims.

### DESCRIPTION OF DRAWINGS

FIG. 1 is a schematic view of a prior art Raman analyzer using a conventional optical circuit.

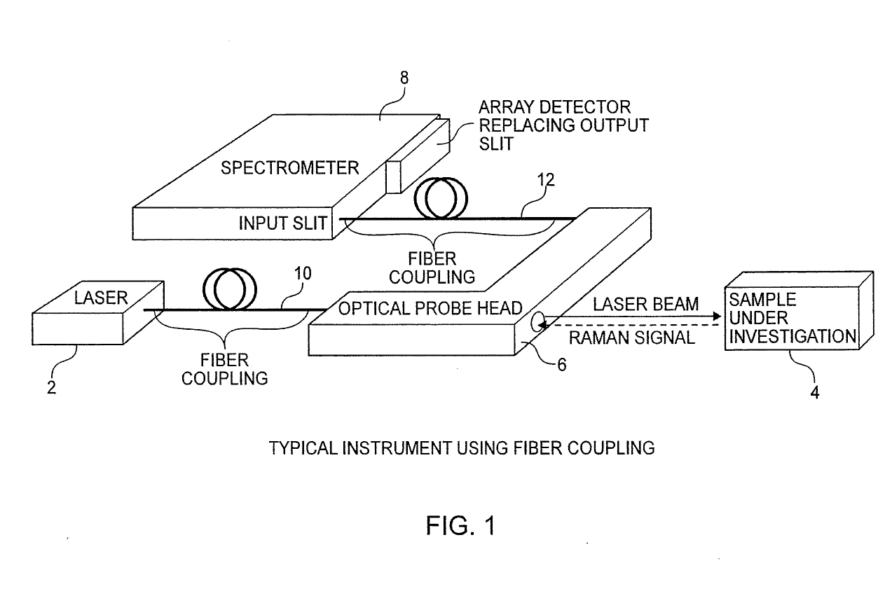

FIG. 2 is a schematic view of a novel optical circuit formed in accordance with the present invention.

FIG. 3 is a schematic view of a novel Raman analyzer formed in accordance with the present invention.

FIG. 4 is a schematic view of a form of laser assembly for use in the Raman analyzer of FIG. 3.

FIG. 5 is a schematic side view of a form of laser assembly for use in the Raman analyzer of FIG. 3.

FIG. 6 is a schematic view of a optical probe head assembly for use in the Raman analyzer of FIG. 3.

FIG. 7 is a schematic view of a spectrometer assembly for use in the Raman analyzer of FIG. 3.

FIG. 8 is perspective view of portable Raman probe.

Like reference symbols in the various drawings indicate like elements.

### DETAILED DESCRIPTION

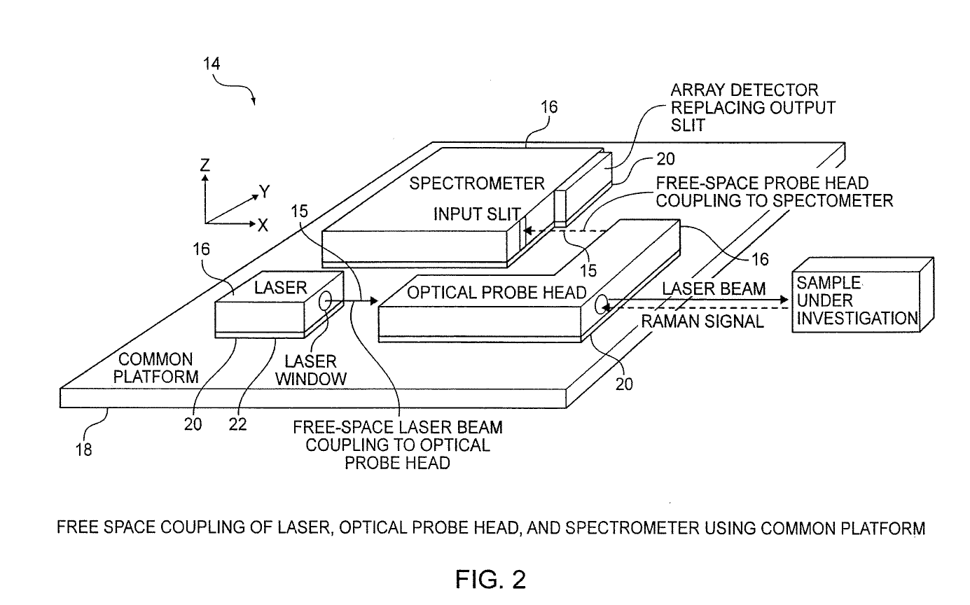

Looking next at FIG. 2, there is shown a novel optical circuit 14 in which free-space coupling 15 is provided between the basic optical elements 16 (e.g., laser assembly, optical probe head assembly, spectrometer assembly, etc.) so as to achieve a compact optical circuit. This is done by mounting the various optical elements 16 on a common platform 18 which is sufficiently mechanically robust as to maintain the free-space optical coupling 15 between the various optical elements 16. The use of free-space optical coupling 15 between the various optical elements 16 permits a more compact optical circuit, since the space requirements of optical fibers can be eliminated.

This approach can be applied to any portable instruments that use two or more optical elements. For example, it can be used with the various optical elements of Raman spectrometer assemblies (i.e., laser assemblies, optical probe head assemblies, spectrometer assemblies, etc.). It can also be used with other optical circuits and/or other optically active or passive elements such as LEDs, broadband semiconductor sources, thin-film block assemblies, apertures, spatial light modulators, moving mirrors, micro-electromechanical devices, etc. In essence, this approach can be used in any portable, optically based instruments so as to reduce their size, thickness and complexity of fiber handling.

It is also possible to address the effects of mechanical shock and vibration on the optical circuit. More particularly, by attaching the various optical elements 16 to the common, mechanically robust platform 18 by means of soft material 20 (e.g., epoxy), the effect of external shock and vibration on the optical circuit can will be minimized. Furthermore, such soft material 20 may be used to attach the common, mechanically robust platform 18 to the rest of the portable instrument so as to dampen the effect of external shock and vibration on the optical circuit. Additionally, if effective heat sinking is required, the various optical elements 16 can be mounted to the common, mechanically robust platform 18 using a thermally conductive material 22 which may be the same as, or different from, the soft material 20. If desired, this thermally conductive material 22 may be harder than the soft material 20 used for shock and vibration dampening. By way of example but not limitation, thermally conductive material 22 may be a metallic material such as solder.

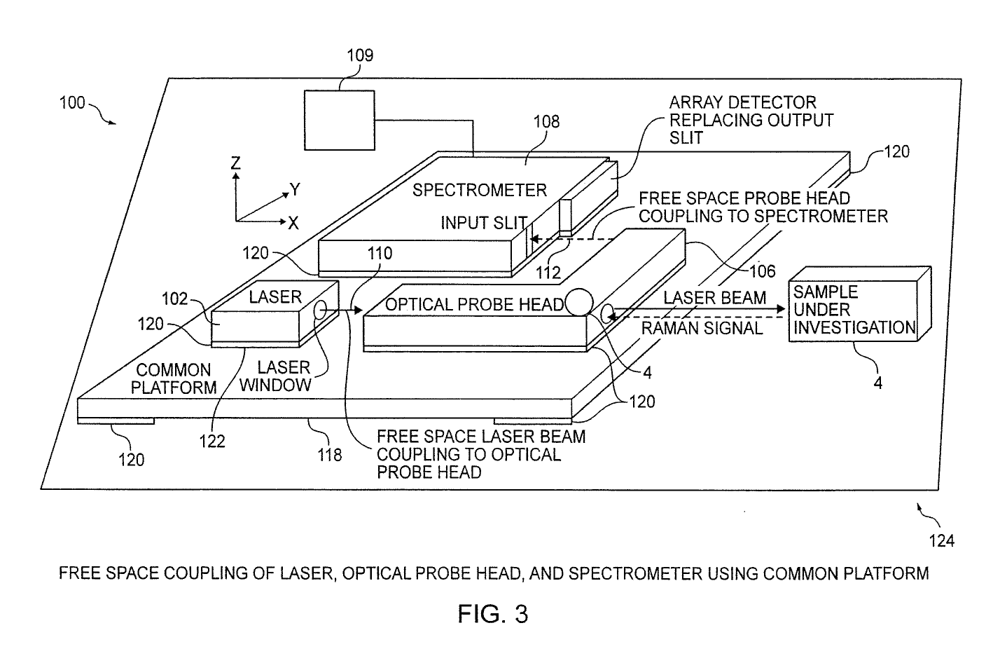

Looking next at FIG. 3, there is shown a novel Raman analyzer 100 comprising a stable and narrow linewidth laser assembly 102 which is used as the Raman pump to impinge on the unknown material 4 through the optical probe head assembly 106, and the resulting Raman optical signal is collected through the same optical probe head assembly 106 and delivered to a spectrometer assembly 108 to identify the spectral signature of the unknown material. Then, this spectral signature is analyzed (e.g., using analysis apparatus 109) so as to identify the unknown material 4. These various optical elements are mounted on a common platform 118 which is sufficiently mechanically robust as to maintain the optical coupling between the various optical elements. A free-space coupling 110 is used to connect laser assembly 102 to the optical probe head assembly 106, and another free space coupling 112 is used to connect optical probe head assembly 106 to the spectrometer assembly 108. Preferably, soft material 120 is used to mount laser assembly 102, optical probe head assembly 106 and spectrometer assembly 108 to common platform 118, and preferably soft material 120 is used to mount common platform 118 to the remainder of the Raman analyzer (e.g., to the casing 124, etc.). Preferably, harder thermally conductive material 122 is used to mount laser assembly 102 to common platform 118.

It should be appreciated that, by using free-space couplings to connect the Raman analyzer's optical elements to one another, the size of the instrument's optical circuit is significantly reduced. In addition, the use of free-space couplings to connect the optical elements to one another minimizes power loss in the optical circuit, thereby reducing laser power requirements and hence the size and weight of the analyzer's battery. Furthermore, by using free-space couplings to connect the optical elements to one another, noise in the optical circuit is reduced, thereby improving the instrument's signal-to-noise ratio and hence improving signal collection time.

It should also be appreciated that, if desired, one or more optical isolators (not shown) can be provided to eliminate optical feedback to the laser, or the laser can be otherwise engineered so as to render it substantially insensitive to optical feedback. Such constructions will be obvious to those skilled in the art in view of the present disclosure.

Furthermore, if desired, means (not shown) may be provided to modify the polarization of the laser light prior to striking the specimen under analysis. Such constructions will be obvious to those skilled in the art in view of the present disclosure.

implementations of laser assembly 102, optical probe head assembly 106 and spectrometer assembly 108 will hereinafter be discussed in further detail.

Laser Assembly 102

In one form, laser assembly 102 comprises a laser assembly of the sort taught in U.S. patent application Ser. No. 11/119,076, filed Apr. 29, 2005 by Daryoosh Vakhshoori et al. for EXTERNAL CAVITY WAVELENGTH STABILIZED RAMAN LASERS INSENSITIVE TO TEMPERATURE AND/OR EXTERNAL MECHANICAL STRESSES, AND RAMAN ANALYZER UTILIZING THE SAME (Attorney's Docket No. AHURA-24), which patent application is hereby incorporated herein by reference.

More particularly, in a Raman analyzer, the laser assembly 102 generates a stable and narrow linewidth light signal which is used as the source of the Raman pump. However, for portable applications, small size and low electrical power consumption efficiency is of the essence. This is because the laser assembly in such a system can account for the majority of the power consumption, and hence dominate the battery lifetime of portable units.

Semiconductor lasers are one of the most efficient lasers known. Semiconductor lasers can have wall-plug efficiencies greater than 50%, which is quite rare for any other type of laser. However, to wavelength-stabilize the semiconductor lasers that are traditionally used for Raman applications, at 785 nm or other operating wavelengths, the most commonly used technique is to provide a diffraction grating in an external cavity geometry so as to stabilize the wavelength of the laser and narrow its linewidth to few inverse centimeter (<50 cm-1). This type of external cavity laser geometry is commonly known as Littrow geometry.

Since such Littrow geometry tends to be temperature-sensitive (i.e., temperature changes can cause thermal expansion of various elements of the assembly which can detune the alignment and change laser wavelength and/or linewidth), a thermo-electric cooler is commonly used to stabilize the temperature to within couple of degrees. However, thermo-electric coolers themselves consume substantial amounts of power, making such an arrangement undesirable in portable applications where power consumption is an important consideration.

Thus, in the aforementioned U.S. patent application Ser. No. 11/119,076, there are disclosed ways to make an external cavity grating laser assembly robust against temperature changes without using “power hungry” temperature controllers. In essence, this is done by carefully choosing (i) the laser mount, the lens mount and the grating mount materials and their dimensions, and (ii) the lens material and its dimensions, so that the laser wavelength shift due to the net thermal expansions of these components effectively cancels the laser wavelength shift due to thermal changes in the grating pitch density, thereby providing wavelength stability in an “uncooled” laser assembly.

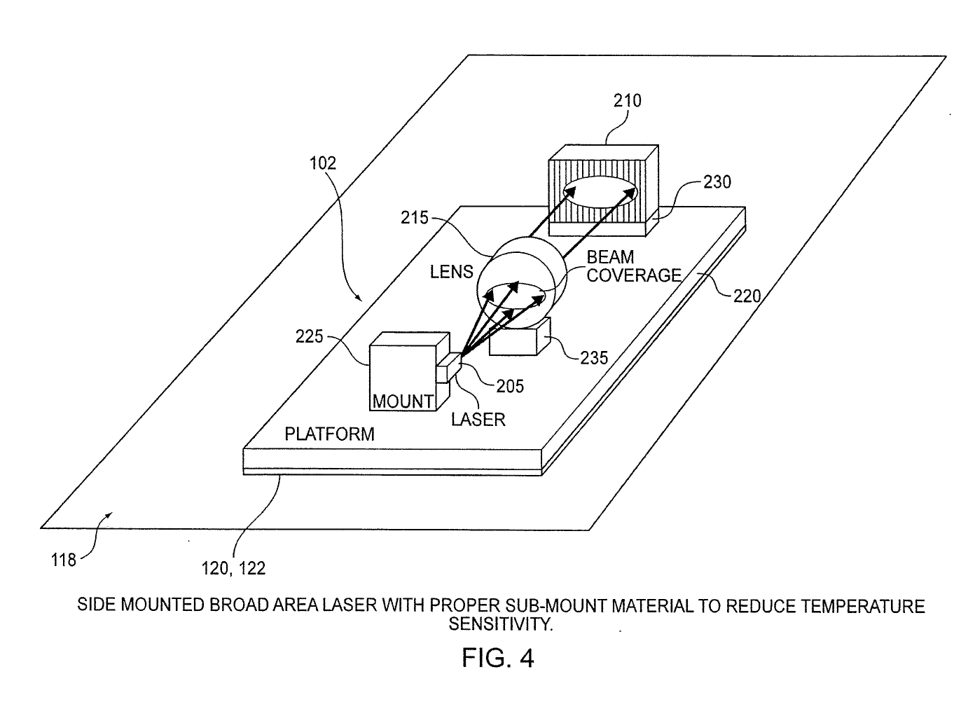

Looking now at FIG. 4, there is shown an external cavity wavelength stabilized laser assembly 102 which is formed in accordance with this approach. More particularly, to achieve high power laser operation (i.e., for use in the Raman pump application), a wavelength stabilized broad area laser 205 is used. Such a laser is commonly characterized by multiple transverse modes that have a single lateral mode operation. Although the techniques presented in this disclosure work well for single spatial mode lasers, their benefits are even more obvious for multiple transverse mode broad area lasers that have single lateral mode operation. Thus, and looking now at FIG. 4, if a broad area laser 205 is mounted on its side such that the plane defined by the diverging angle of the lateral mode is parallel to the plane of the laser's platform 220 (which is in turn mounted to the aforementioned common, mechanically robust platform 118 using soft material 120 and/or thermally conductive material 122), and the grooves of the diffraction grating 210 extend perpendicular to the plane of the platform 220, the laser wavelength becomes relatively insensitive to the vertical displacement of the laser mount 225, lens mount 235, and grating mount 230, and the vertical displacement of the laser 205 and lens 215. Of course, the grating pitch density may still change with temperature, thus effecting laser wavelength. However, by properly choosing the material of the laser mount 225 so that it will cancel the effect of the grating pitch density change on wavelength, a temperature-insensitive operation can be achieved.

With the side-mounted geometry shown in FIG. 4, a laser mount material can be chosen so as to cancel the grating pitch density change effect on laser wavelength for a relatively large temperature range. In practice, this technique has been applied to a broad area laser emitting more than 500 mW at 785 nm to achieve less than 0.02 nm wavelength shift for a temperature range from −10 degrees C. to +60 degrees C., by using copper as the laser mount material with standard grating material.

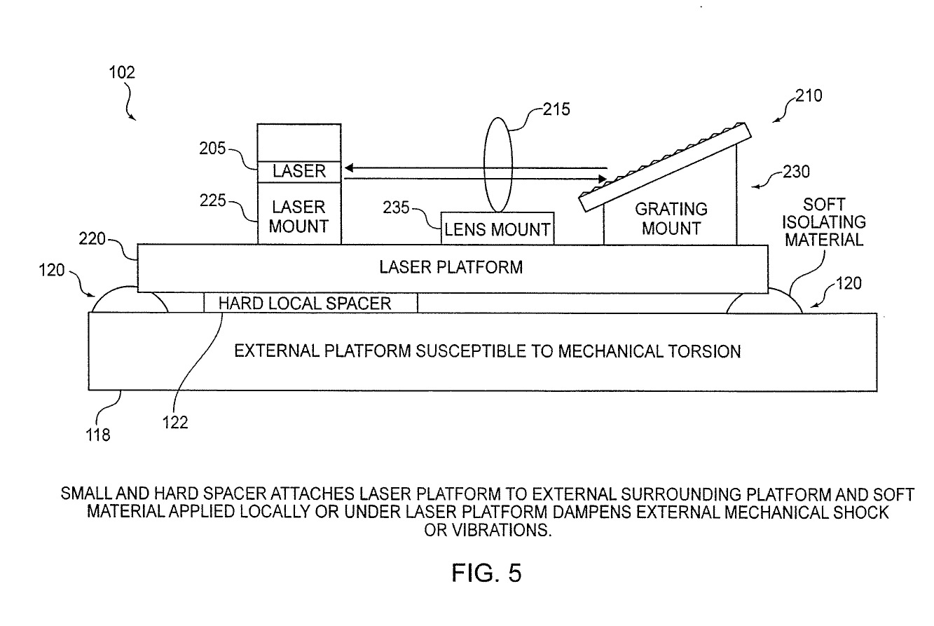

Looking next at FIG. 5, there is shown further details of this form of external cavity wavelength stabilized laser assembly 102. More particularly, the laser platform 220 can be, to at least some extent, mechanically isolated from the outside (e.g., from the external common platform 118) by using segments of soft isolating material 120 and a relatively small, thin, hard local spacer 122. The segments of soft isolating material 120 serve as shock/vibration absorbers to dampen external forces, and may comprise epoxy or similar materials. The hard local spacer 122 provides relatively rigid mechanical attachment to the common, mechanically robust platform 118 and can be thermally conductive so as to heat sink the laser 205 (in which case the spacer 122 is preferably attached directly beneath the laser mount 225). Thus, in this aspect, the laser platform 220 is attached to the common platform 118 via (i) segments of soft material 120, so as to reduce the effect of mechanical deformations and distortions on the laser assembly 102, and (ii) a small, hard and potentially thermally conductive spacer 122.

Optical Probe Head Assembly 106

In one form, optical probe head assembly 106 comprises a probe head assembly of the sort taught in U.S. patent application Ser. No. 11/117,940, filed Apr. 29, 2005 by Peidong Wang et al. for METHOD AND APPARATUS FOR CONDUCTING RAMAN SPECTROSCOPY (Attorney's Docket No. AHURA-2230), which patent application is hereby incorporated herein by reference.

More particularly, in the Raman analyzer, optical probe head assembly 106 is used to deliver the laser light (as the Raman pump) to the unknown material 4, and to collect the resulting Raman optical signal and deliver it to spectrometer assembly 108.

Preferably, and as taught in U.S. patent application Ser. No. 11/117,940, optical probe head assembly 106 is configured so that the Raman analyzer may be used in three different modes of use. In a first mode of use, the Raman probe allows the user to maintain distance from the specimen using a conical standoff, which provides both distance control and laser safety by limiting the exposed beams. The second mode of use allows the user to remove the conical standoff so as to maintain distance control by hand or other means. The third mode of use allows a specimen vial to be inserted directly within the probe optics assembly. Optical probe head assembly 106 achieves all of these modes of use, while providing a compact design, thereby permitting its use in a compact, lightweight and highly portable Raman analyzer.

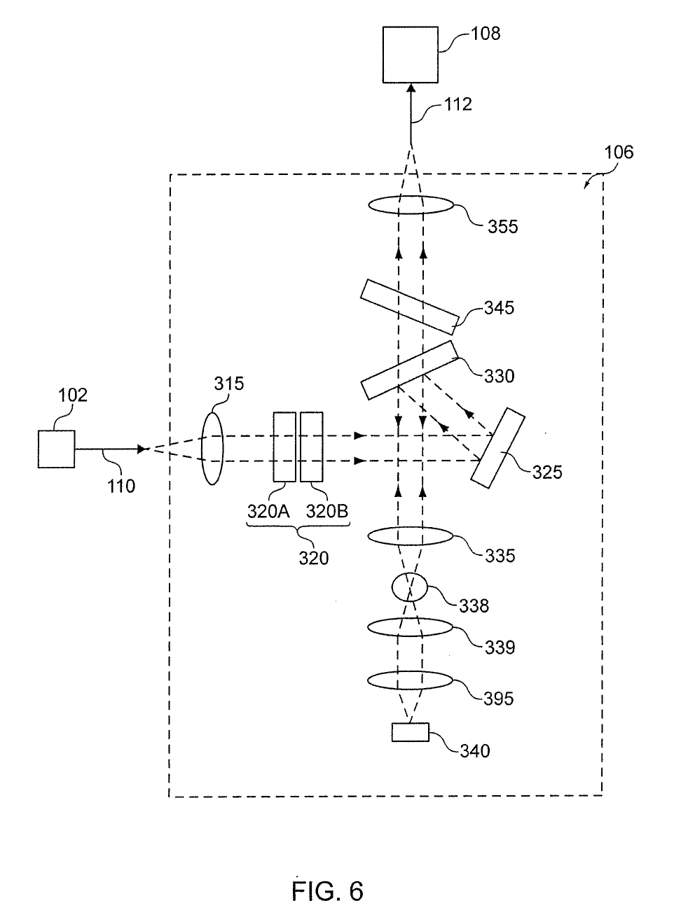

More particularly, and looking now at FIG. 6, there is shown an optical probe head assembly 106 which provides the three aforementioned modes of use. With this construction, the output of laser assembly 102 is delivered through a free-space coupling 110 and collimated through a lens 315. A bandpass filter 320 (or multiple combination of bandpass filters 320A, 320B) is used to pass the laser excitation light and to block spurious signals associated with the laser, etc. The spurious signals associated with the laser generally comprise ASE from the laser. The laser excitation light is then reflected by a laser line reflector 325 (e.g., at a 22.5 degree Angle of Optical Incidence, AOI) and a filter 330 (e.g., at a 22.5 degree AOI), and then it is focused through lens 335 on specimen vial receptacle 338, or passed through the specimen vial receptacle 338 and through a focus lens 339, and then through another focus lens 395, to a specimen location 340. In this respect it should be appreciated that, for the purposes of the present disclosure, certain AOI values are used, however, the AOI values may vary with the particular geometry employed, e.g., the AOI values may be anywhere from 5 degree AOI to 50 degree AOI. In one embodiment, filter 330 is preferably a long-pass filter. In this embodiment, laser line reflector 325 is preferably a simple reflector to reflect the laser light. After the laser excitation light has been projected on the specimen, the Raman signal is re-collimated through lens 335 (where the specimen is located in vial receptacle 338), or lenses 395, 339 and 335 (where the specimen is located at specimen location 340) and passed through filter 330. Alternatively, the Raman signal may pass through multiple filters (i.e., in addition to passing through filter 330, the Raman signal may pass through additional filter 345 (e.g., at a 22.5 degree AOI). In one embodiment, additional filter 345 is preferably also a long-pass filter. When the Raman signal from the specimen is passed through filter 330, filter 330 serves a second purpose at this time, i.e., it blocks the laser line. Filters 330 and 345 can provide up to >OD10 filtration of the laser line before the light is redirected by focus lens 355 across free-space coupling 112 to spectrometer assembly 108 which analyzes the Raman signature of the specimen, whereby to identify the specimen. In one embodiment, filters 330 and/or 345 may comprise long-pass filters.

Spectrometer Assembly 108

In one form, the spectrometer assembly 108 comprises a spectrometer assembly of the sort taught in U.S. patent application Ser. No. 11/119,139, filed Apr. 30, 2005 by Daryoosh Vakhshoori et al. for LOW PROFILE SPECTROMETER AND RAMAN ANALYZER UTILIZING THE SAME (Attorney's Docket No. AHURA-26), which patent application is hereby incorporated herein by reference.

More particularly, in a Raman analyzer, the spectrometer assembly identifies the spectral signature of the unknown material, using the Raman optical signal obtained from the unknown material. For portable applications, small spectrometer size is essential.

Thus, in one form, spectrometer assembly 108 comprises a spectrometer assembly of the sort taught in U.S. patent application Ser. No. 11/119,139.

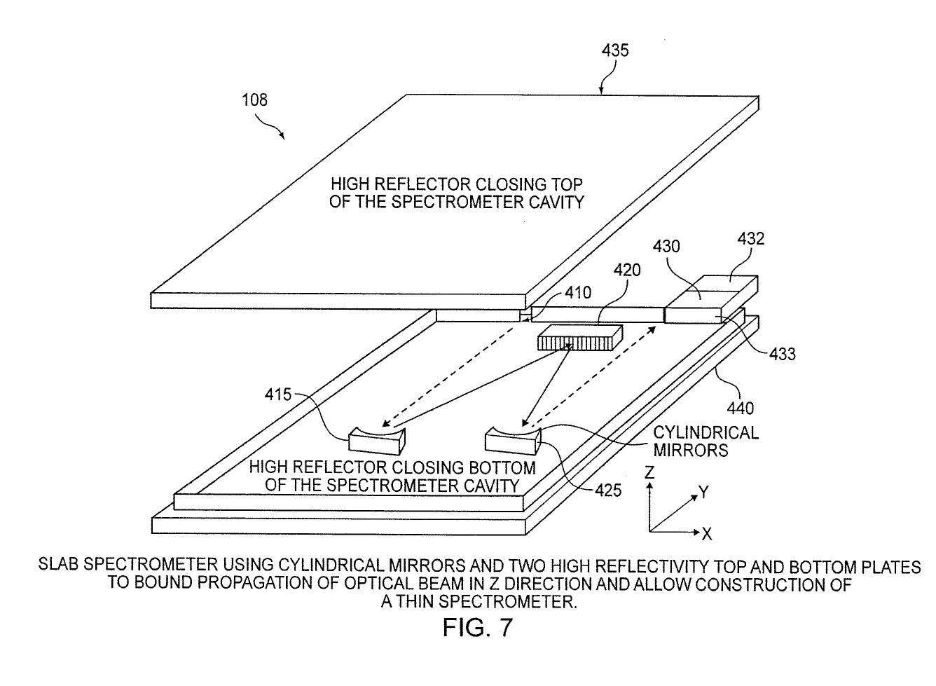

More particularly, and looking now at FIG. 7, there is shown a from of spectrometer assembly 108. Light enters the spectrometer 108 through an input slit 410. The slit of light is imaged through a collimating element 415 (e.g., a lens or mirror), a dispersive optical element 420 (e.g., a reflection diffraction grating, a transmission diffraction grating, a thin film dispersive element, etc.) and focusing element 425 (e.g., a lens or mirror) to a detector assembly 430. Detector assembly 430 may comprise a single detector (e.g., a charge coupled device, or “CCD”) located beyond an output slit (where dispersive optical element 420 is adapted to rotate), or an array of detectors (where dispersive optical element 420 is stationary), etc., as is well known in the art. A thermoelectric cooler (TEC) 432 may be used to cool detector assembly 430 so as to improve the performance of the detector assembly (e.g., by reducing detector “noise”). A wall 433 may be used to separate detector assembly 430 from the remainder of the spectrometer; in this case, wall 433 is transparent to the extent necessary to pass light to the detector or detectors.

the spectrometer assembly 108 utilizes a unique construction so as to achieve a reduction in the height of the spectrometer assembly, whereby to facilitate its use in a compact, lightweight and highly portable Raman analyzer. Looking now at FIG. 7, this reduction in the height of the spectrometer is achieved by utilizing optical elements 415 and 425 which can adequately maintain the desired optical parameters in the x-y plane (see the x-y-z coordinate symbol on FIG. 7) while having a reduced size in the z direction.

In one form, the optical elements 415 and 425 can be spherical elements which have been cut (or diced) down in the z direction so as to reduce their dimension in the z direction. In other words, optical elements 415 and 425 can be standard bulk curved elements which are completely symmetrical about their optical axis except that they have been cut down in the z direction so as to provide a lower spectrometer profile. For the purposes of the present description, such optical elements 415 and 425 may be considered to be “diced spherical” in construction. It is believed that diced spherical elements which have an aspect ratio of approximately 3:1 (x:z) or greater provide superior results, achieving a significant reduction in spectrometer profile while still maintaining acceptable levels of performance.

In another form, the optical elements 415 and 425 can be “cylindrical” in construction, in the sense that they provide a spherical geometry in the x-y plane but a slab geometry in the z plane. In other words, with the cylindrical construction, the optical elements 415 and 425 have a surface profile which is analogous to that of a cylinder. It is believed that cylindrical elements which have an aspect ratio of approximately 3:1 (x:z) or greater provide superior results, achieving a significant reduction in spectrometer profile while still maintaining acceptable levels of performance.

It is to be appreciated that still other optical geometries may be used in optical elements 415 and 425 so as to form a reduced profile spectrometer having acceptable levels of spectrometer performance. In general, these geometries maintain the desired optical parameters in the x-y plane while having a reduced size in the z direction. For example, various non-spherically symmetrical geometries (i.e., those not symmetrical about all axes) may be utilized to form optical elements 415 and 425.

Thus, in this spectrometer assembly 108, collimating element 415 and focusing element 425 are formed so as to maintain the desired optical parameters in the x-y plane while having a reduced size in the z direction. In one form, collimating element 415 and focusing element 425 are formed with non-spherically symmetrical geometries. In another form, collimating element 415 and focusing element 425 are formed with diced spherical geometries. In another form, collimating element 415 and focusing element 425 are formed with cylindrical constructions. Alternatively, combinations of such constructions may be used.

Still looking now at FIG. 7, spectrometer assembly 108 may be open or closed on its top and bottom sides (i.e., as viewed along the z axis). Preferably, however, spectrometer assembly 108 is closed on both its top and bottom sides with plates 435, 440 so as to seal the spectrometer cavity.

Significantly, in another novel aspect, plates 435 and 440 may be formed with at least some of their inside faces comprising high reflectivity surfaces, so that the light rays are bounded between high reflectivity mirrors in the z direction, whereby to utilize as much of the light entering input slit 410 as possible.

As noted above, detector assembly 430 may comprise a single detector (e.g., a CCD) located beyond an output slit (where dispersive optical element 420 is adapted to rotate), or an array of detectors (where dispersive optical element 420 is stationary), etc., as is well known in the art. A thermoelectric cooler (TEC) 432 is preferably used to cool detector assembly 430 so as to improve the performance of the detector assembly (e.g., by reducing detector “noise”). A wall 433 is preferably used to separate detector assembly 430 from the remainder of the spectrometer; in this case, wall 433 is transparent to the extent necessary to pass light to the detector or detectors.

Additionally, and in another embodiment, the detector assembly 430 is hermetically sealed, and the interior is filled with a noble gas (e.g., helium, neon, argon, krypton, xenon or radon), so as to reduce the power consumption of the TEC 432 used to cool the detector assembly 430.

More particularly, by replacing the air inside the detector assembly 430 with a noble gas, the heat loading of the TEC 432 (due to the convection of air from the side walls of the assembly to the surface of the detector) is reduced, e.g., by a factor of two, which results in a corresponding reduction in the power consumption of the TEC. This is a significant advantage, since the low profile spectrometer 108 may be used in a hand held or portable application requiring a battery power supply.

It should also be appreciated that by hermetically sealing detector assembly 430, condensation can be avoided where the outside temperature becomes higher than the temperature setting of the TEC (and hence the temperature of the detector). Such condensation is undesirable, since it may occur on the detector, which may cause light scattering off the detector, thereby compromising detection accuracy.

Analysis Apparatus 109

In one form, the Raman analyzer 100 comprises an analysis apparatus 109 of the sort taught in U.S. patent application Ser. No. 11/119,147, filed Apr. 30, 2005 by Christopher D. Brown et al. for SPECTRUM SEARCHING METHOD THAT USES NON-CHEMICAL QUALITIES OF THE MEASUREMENT (Attorney's Docket No. AHURA-33), which patent application is hereby incorporated herein by reference.

More particularly, Raman analyzer 100 also comprises an analysis apparatus 109 which receives the Raman signature determined by spectrometer assembly 108 and, using that Raman signature, identifies the specimen material. The analysis apparatus 109 preferably comprises an on-board microcomputer which is programmed to use appropriate algorithms and material libraries (also included within the portable unit, installed either at the time of manufacture or thereafter, e.g., by insertion of an external memory card such as a CompactFlash card, etc.), to identify the unknown material 4. Preferably, analysis apparatus 109 uses analysis logic and algorithms of the sort taught in U.S. patent application Ser. No. 11/119,147 (although other forms of analysis apparatus may also be used) to compare the Raman signature (obtained by spectrometer assembly 108) with the information contained in the on-board material libraries, whereby to identify the unknown material 4.

In one form, analysis apparatus 109 also comprises an on-board database containing information about different materials (e.g., color, texture, odor, boiling point, freezing point, toxicity, possible therapies to counteract exposure to the material, etc.). Thus, after analysis apparatus 109 is used to identify the unknown material 4, analysis apparatus 109 can also be used to supply the user with relevant information about the identified material. In this respect it should also be appreciated that Raman analyzer 100 includes various user interface controls to facilitate user interaction with analysis apparatus 109, as well as with other components of the analyzer.

### EXAMPLES

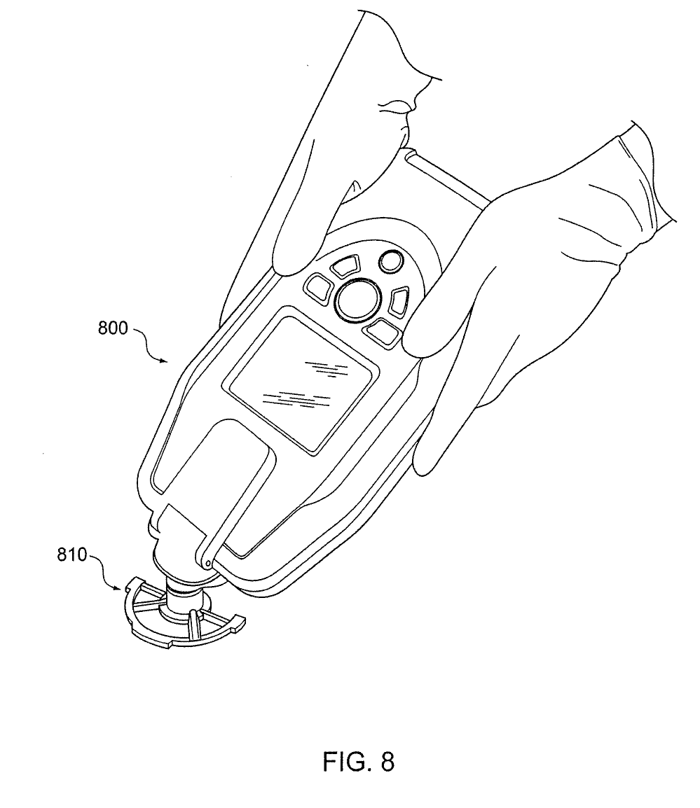

In one embodiment, referring to FIG. 8, a Raman optical probe 800 has 3 modes of use. Two of the modes are “point-and-shoot” and the third is a vial measurement. The first mode of use is to place the targeting stability foot (conical standoff 810) onto the sample or container to be tested. In this mode, a metal cone contains the laser beam and keeps the needed focal distance to the sample. The outer shield blocks any potentially scattered laser radiation. A second mode of use is to remove the laser cone and targeting foot to avoid coming in direct contact with the sample to be tested. In this mode, the unit is ˜1.5 centimeters above the sample, thus limiting potential contamination and user exposure. The third mode is a direct vial measurement. A hatch is present above the screen. When lifted, a hole is present for receiving a standard test vial. The vial is positioned to allow measurements of both powders and liquids. The vials can then be saved for evidence collection or a secondary laboratory test. Classification of the molecular signature obtained from the probe hardware can be performed using custom decision support software executing on an onboard PXA255 400 MHz single board computer. The outer dimensions of the Raman optical probe are approximately 10 inches by 6 inches by 2 inches and the weight is approximately 3 pounds.

In another embodiment, the laser, probe optics, and thin-pack spectrometer are integrated into a single optical platform without interconnection using optical fibers. Integration of the laser, delivery and collection optics, and the spectrometer in free space without the use of fiber optic interconnections greatly reduces the space required within the probe and can provide a single ultra-thin optical package measuring only 3 inches by 5 inches by 0.25 inches. The laser, probe optics, and spectrometer reside on a single common platform with each element free space coupled to the next. The effect of mechanical shock and vibration on the integrated engine can be mitigated by attaching the common platform by soft compliant material. The outer dimensions of the Raman optical probe are reduced to less than approximately 4 inches by 6 inches by 0.75 inches and the weight is less than 0.5 pounds.

Modifications

It is to be understood that the present invention is by no means limited to the particular constructions herein disclosed and/or shown in the drawings, but also comprises any modifications or equivalents within the scope of the following claims.

What is claimed is:

1. An apparatus comprising:
a handheld Raman analyzer comprising:
a common platform;
a laser assembly mounted on a laser platform, the laser platform supported on the common platform by a first material and a second thermally conductive material wherein the first material is softer than the second material;
an optical probe head assembly disposed on the common platform, the optical probe head assembly spaced apart from the laser assembly;
a spectrometer assembly disposed on the common platform, the spectrometer assembly spaced apart from the optical probe head assembly; and
an analysis apparatus configured to identify a specimen based on a Raman signature received from the spectrometer;
wherein the laser assembly is optically coupled to the optical probe head assembly by at least a first free-space coupling region and the optical probe head assembly optically coupled to the spectrometer assembly by at least a second free-space coupling region.

2. The apparatus of claim 1, wherein the laser assembly is entirely optically coupled to the optical probe head assembly by the first free-space coupling region.

3. The apparatus of claim 2, wherein the optical probe head assembly is entirely optically coupled to the spectrometer assembly by the second free-space coupling region.

4. The apparatus of claim 1, wherein the first material is sufficiently soft to limit the transmission of vibration between the common platform and the laser assembly.

5. The apparatus of claim 1, wherein the second material is configured to transfer heat from the laser assembly and laser platform to the common platform.

6. The apparatus of claim 1, wherein the first material and the second material are spaced apart from each other.

7. The apparatus of claim 1, wherein the first material comprises epoxy.

8. The apparatus of claim 7, wherein the second material comprises solder.

9. The apparatus of claim 1, an optical probe head assembly is supported on the common platform by the first material.

10. The apparatus of claim 9, wherein the spectrometer assembly is supported on the common platform by the first material.

11. The apparatus of claim 1, wherein the Raman analyzer weighs less than 0.5 pounds.

12. The apparatus of claim 1, wherein outer dimensions of the Raman analyzer are less than 10 inches by 6 inches by 2 inches.

13. The apparatus of claim 12, wherein outer dimensions of the Raman analyzer are less than 4 inches by 6 inches by 0.75 inches.

14. The apparatus of claim 13, wherein the common platform extends in an x-y plane; and
wherein the spectrometer assembly comprises: a collimating optical element configured to receive and disperse input light; a dispersive optical element configured to disperse light received from the collimating element; and a focusing optical element configured to focus light received from the dispersive optical element on a detector assembly; wherein the collimating element and focusing element are formed with an aspect ratio of approximately 3:1 (x:z) or greater.

15. The apparatus of claim 1, wherein the optical probe head assembly comprises a removable conical standoff which, when attached, limits a distance between an optical component of the optical probe head assembly and an external specimen and the optical probe head assembly is configured to receive a specimen vial within the optical probe head assembly.

16. The apparatus of claim 1, wherein the spectrometer assembly contains at least one optical element in a first chamber filled with ambient air and a detector assembly which is hermetically sealed and filled with a noble gas.

17. The apparatus of claim 1, wherein the laser assembly comprises an uncooled external cavity grating semiconductor laser assembly configured to provide a stable and narrow linewidth signal.

18. The apparatus of claim 1, wherein the optical probe head assembly is configured to direct Raman pump light toward a specimen and to receive a resulting Raman signal from the specimen.

19. The apparatus of claim 18, wherein the optical probe head assembly comprises a detachable standoff member configured to maintain a distance between a specimen and a first optical element of the optical probe head assembly; and wherein the optical probe head assembly defines a specimen vial receptacle.

20. An apparatus comprising:
a handheld Raman analyzer with outer dimensions less than 10 inches by 6 inches by 2 inches; the Raman analyzer comprising:
a common platform;
a laser assembly mounted on a laser platform, the laser platform supported on the common platform by a first material and a second thermally conductive material wherein the first material is softer than the second material;
an optical probe head assembly configured to direct Raman pump light toward a specimen and to receive a resulting Raman signal from the specimen, the optical probe head assembly disposed on the common platform, the optical probe head assembly spaced apart from the laser assembly, wherein the optical probe head assembly comprises a removable conical standoff which, when attached, limits a distance between the Raman analyzer and an external specimen and the optical probe head assembly is configured to receive a specimen vial within the optical probe head assembly;
a spectrometer assembly disposed on the common platform, the spectrometer assembly spaced apart from the optical probe head assembly; and
an analysis apparatus configured to identify a specimen based on a Raman signature received from the spectrometer;
wherein the laser assembly is optically coupled to the optical probe head assembly by at least a first free-space coupling region and the optical probe head assembly optically coupled to the spectrometer assembly by at least a second free-space coupling region, wherein the laser assembly comprises an uncooled external cavity grating semiconductor laser assembly configured to provide a stable and narrow linewidth signal;
wherein the first material and the second material are spaced apart from each other.

21. The apparatus of claim 20, wherein the laser assembly is entirely optically coupled to the optical probe head assembly by the first free-space coupling region and the optical probe head assembly is entirely optically coupled to the spectrometer assembly by the second free-space coupling region.

22. The apparatus of claim 20, wherein the first material is sufficiently soft to limit the transmission of vibration between the common platform and the laser assembly.

23. The apparatus of claim 20, wherein the second material is configured to transfer heat from the laser assembly and laser platform to the common platform.

24. The apparatus of claim 20, an optical probe head assembly is supported on the common platform by the first material and the spectrometer assembly is supported on the common platform by the first material.

25. The apparatus of claim 20, wherein the Raman analyzer weighs less than 0.5 pounds.

26. The apparatus of claim 20, wherein outer dimensions of the Raman analyzer are less than 4 inches by 6 inches by 0.75 inches.

27. The apparatus of claim 20, wherein the spectrometer assembly contains at least one optical element in a first chamber filled with ambient air and a detector assembly which is hermetically sealed and filled with a noble gas.
